(19) United States
(12) Patent Application Publication
(10) Pub. No.: US 2022/0409471 A1
(43) Pub. Date: Dec. 29, 2022

(54) MASSAGE WAIST PILLOW

(71) Applicant: Jiangsu Mingteng Health Products Co., Ltd, Yancheng (CN)

(72) Inventors: Chuankui Du, Shanghai (CN); Saihua Chen, Shanghai (CN); Jinnian Dong, Shanghai (CN)

(73) Assignee: Jiangsu Mingteng Health Products Co., Ltd, Yancheng (CN)

(21) Appl. No.: 17/900,894

(22) Filed: Sep. 1, 2022

(30) Foreign Application Priority Data
Jul. 25, 2022 (CN) 202221934387.4

(51) Int. Cl. A61H 7/00

(52) U.S. Cl. CPC A61H 7/001; A61H 2201/1628; A61H 2205/08; A61H 2201/1654; A61H 2201/0192; A61H 2201/1238; A61H 2201/1695; A61H 2201/1623; A61H 2201/1671; A61H 2205/081; A61H 2201/0134; A61H 2201/0103

(57) ABSTRACT

The present disclosure is applicable to the technical field of massage apparatuses, and provides a massage waist pillow. The waist pillow main body includes a sponge waist pillow main body, a massage unit and an air bag; a groove is reserved in an area of the sponge waist pillow main body close to the back of the waist of a user; a support plate is arranged in the groove; the air bag is arranged at a bottom of the groove and is mounted on the support plate; the massage unit is arranged in the groove and above the air bag; and the air bag is located in an interlayer between the massage unit and the support plate.

### TECHNICAL FIELD

The present disclosure belongs to the technical field of massage apparatuses, and particularly relates to a massage waist pillow.

### BACKGROUND

A massage unit of an existing electric massage waist pillow is often higher. When a massage function is not required, if the electric massage waist pillow is used as an ordinary waist pillow, the protruding massage unit will push against the lower back of a user, leading to discomfort.

### SUMMARY

An embodiment of the present disclosure aims to provide a massage waist pillow, and aims at solving the problem of discomfort caused by pressure on the lower back since a massage unit protrudes when an existing massage waist pillow is not used for massaging.

The embodiment of the present disclosure is achieved below: A massage waist pillow includes:

a sponge waist pillow main body, a massage unit, an air bag, an air pump, an air valve and an electric control plate; a groove is reserved in an area of the sponge waist pillow main body close to the back of the waist of a user; a support plate is arranged in the groove; the air bag is fixed on the support plate; the massage unit is arranged in the above groove and is located above the air bag; the air bag is arranged in an interlayer between the massage unit and the support plate; an outer side of the air bag is fixedly connected with an air inlet and outlet hose; and the air inlet and outlet hose is connected with the air pump and the air valve.

In a further technical solution, the outline of the air bag is matched with the outline of the massage unit, and the air bag is fixed at a bottom of the massage unit.

In a further technical solution, the air bag is inflated to push the massage unit out of the groove, so that the massage unit protrudes towards an outer side of a plane of the sponge waist pillow main body; and the air bag is deflated to pull the massage unit into the groove, so that the massage unit moves towards one side of the bottom of the groove.

In a further technical solution, an outer surface of the sponge waist pillow main body is wrapped with a waist pillow cloth cover.

In a further technical solution, the electric control plate is connected to the air pump and the air valve through internal wires.

In a further technical solution, the electric control plate is connected to the massage unit through an internal wire.

In a further technical solution, a control box is mounted on an outer side of the sponge waist pillow main body; a button and the electric control plate are arranged in the control box; and the button is connected to the electric control plate.

In a further technical solution, the electric control plate in the control box is connected to a rechargeable battery through an internal wire; and the rechargeable battery supplies electric energy to the air pump, the air valve and the massage unit through the electric control plate.

According to the massage waist pillow provided by the embodiment of the present disclosure, a user puts the sponge waist pillow main body on a chair or a sofa and leans against the sponge waist pillow main body with the lower back. When the user needs massage, the electric control plate is controlled through the button, and the electric control plate controls the massage unit to massage the lower back; if higher massage strength is required, the user can inflate the air bag to increase a height of the air bag, so as to increase a pressure applied by the massage unit to the lower back, thus increasing the massage strength; if lower massage strength is required, the user can deflate the air bag to decrease the height of the air bag, so as to reduce the pressure applied by the massage unit to the lower back, thus decreasing the massage strength; after the user turns off the massage unit, the air bag can be completely deflated to completely decrease the height of the air bag, so that the massage unit is thoroughly made to be away from the lower back of the user.

### BRIEF DESCRIPTION OF THE DRAWINGS

FIG. 1 is a schematic structural diagram of a massage waist pillow provided in an embodiment of the present disclosure.

FIG. 2 is an exploded diagram of a massage waist pillow provided in an embodiment of the present disclosure.

In the drawings: sponge waist pillow main body 1, massage unit 2, air bag 3, air inlet and outlet hose 4, support plate 5, control box 6, control button 7, electric control plate 8, internal wire 9, rechargeable battery 10, waist pillow cloth cover 11, air pump 12, and air valve 13.

### DETAILED DESCRIPTION OF THE EMBODIMENTS

In order to make the objectives, technical solutions and advantages of the present disclosure clearer, the present disclosure is further described in detail below with reference to accompanying drawings and embodiments. It should be understood that the specific embodiments described here are merely to illustrate and explain the present disclosure, and not intended to limit the present disclosure.

Specific implementation of the present disclosure is described in detail below in combination with specific embodiments.

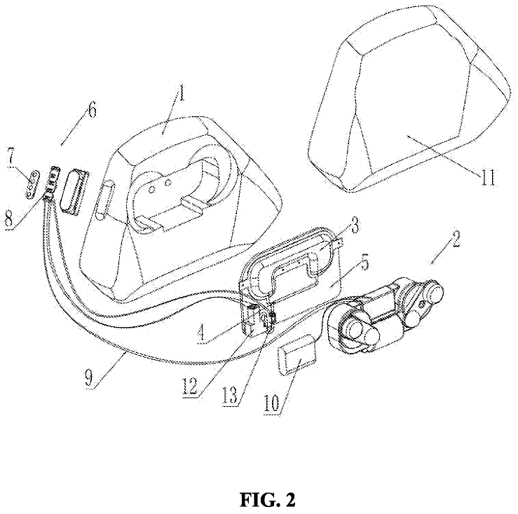

As shown in FIG. 2, a massage waist pillow provided in one embodiment of the present disclosure includes:

a sponge waist pillow main body 1, a massage unit 2 and an air bag 3. A groove is reserved in an area of the sponge waist pillow main body 1 close to the back of the waist of a user; a support plate 5 is arranged in the groove; the air bag 3 is fixed on the support plate 5; the massage unit 2 is arranged in the above groove and is located above the air bag 3; and the air bag 3 is arranged in an interlayer between the massage unit 2 and the support plate 5.

In the embodiment of the present disclosure, the massage unit 2 includes two rotary massage heads; each rotary massage head is provided with a plurality of protruding points; and the massage unit 2 can massage the lower back of the user through the rotation of the rotary massage heads. During use, the groove on the sponge waist pillow main body 1 is fitted to the waist of the user; the air bag 3 is inflated to push the massage unit 2 to move towards an open end of the groove to press against the waist of the user; at this time, the massage unit 2 massages the user by rotating the rotary massage heads; when massage is not required, the air bag 3 is deflated to pull the massage unit 2 to move towards the inner side of the groove, thus avoiding the massage unit 2 from protruding from the sponge waist pillow main body 1; a pressure applied by the rotary massage heads of the massage unit to the back of the user decreases; at this time, the massage waist pillow can be used as an ordinary back cushion; and it is convenient to switch the use modes, so that the massage waist pillow is conveniently applicable to different use environments.

As shown in FIG. 2, as one preferable embodiment of the present disclosure, the outline of the air bag 3 is matched with the outline of the massage unit 2, and the air bag is fixed at a bottom of the massage unit 2.

In the embodiment of the present disclosure, the air bag 3 arranged on the sponge waist pillow main body 1 just corresponds to the waist position of the user, so that it is convenient to massage the waist of the user.

As shown in FIG. 2, as one preferable embodiment of the present disclosure, the air bag 3 is inflated to push the massage unit 2 out of the groove, so that the massage unit 2 protrudes towards a plane of the sponge waist pillow main body 1; and the air bag 3 is deflated to pull the massage unit 2 into the groove, so that the massage unit 2 moves towards one side of the open end of the groove, and the rotary massage heads of the massage unit 2 are lower than the plane of the sponge waist pillow main body 1.

In the embodiment of the present disclosure, the massage unit 2 extends and retracts since the air bag 3 is inflated and deflated.

As shown in FIG. 2, as one preferable embodiment of the present disclosure, the air inlet and outlet hose 4 is connected with an air pump 12 and an air valve 13; the air pump 12 and the air valve 13 are fixed at an edge of the support plate 5; and the air bag 3 is connected to the air pump 12 and the air valve 13 respectively through the air inlet and outlet hose 4.

In the embodiment of the present disclosure, the air pump 12 can inflate the air bag 3 through the air inlet and outlet hose 4; the air valve 13 is used for controlling an air supply volume and air discharge; the air bag 3 is formed by combining an upper flexible thermoplastic polyurethane (TPU) material and a lower flexible TPU material; and when the two pieces of materials are combined, peripheries of the materials are welded by high-frequency waves.

As shown in FIG. 2, a boundary dimension of the air bag 3 and a dimension of the massage unit 2 are in concert with each other, that is, the air bag 3 is configured to be in a similar shape to the massage unit 2. When the air bag 3 is inflated to increase the height and deflated to decrease the height, the massage unit 2 can be supported.

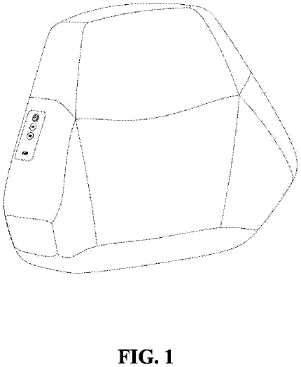

As shown in FIG. 1 to FIG. 2, as one preferable embodiment of the present disclosure, an outer surface of the sponge waist pillow main body 1 is wrapped with a waist pillow cloth cover 11.

In the embodiment of the present disclosure, the outline of a back surface of the sponge waist pillow main body 1 is fitted to the outline of a surface of a back rest of a swivel chair, and a front surface of the sponge waist pillow main body 1 is fitted to the outline of the lower back of the user.

As shown in FIG. 2, as one preferable embodiment of the present disclosure, a mounting slot is arranged on the outer side of the sponge waist pillow main body 1; the control box 6 is fixedly connected into the mounting slot; a button 7 and an electric control plate 8 are arranged inside the control box 6; the button 7 is connected to the electric control plate 8; a rechargeable battery 10 is fixedly mounted below the massage unit 2; the rechargeable battery 10 is connected to the electric control plate 8 through an internal wire 9; the electric control plate 8 is connected to the air pump 12, the air valve 13 and the massage unit 2 through internal wires 9; and the rechargeable battery 10 supplies electric energy to the air pump 12, the air valve 13 and the massage unit 2 through the electric control plate 8.

In the embodiment of the present disclosure, the user can control the massage unit 2 to start and stop through the control button 7; the user can control the air pump 12 to supply air to the air bag 3 and to stop the air supply through the control button 7; the user can control the air valve 13 to deflate the air bag 3 through the control button 7; and the air bag 3 is inflated via the air supplied by the air pump 12 and is deflated by the air valve 13.

The above embodiment of the present disclosure provides a massage waist pillow. A user puts the sponge waist pillow main body 1 on a chair and leans against the sponge waist pillow main body 1 with the lower back. When the user needs massage, the massage unit 2 is turned on through the control button 7 to massage the lower back; if higher massage strength is required, the electric control plate 8 can be controlled through the control button 7 to trigger the air pump 12 to inflate the air bag 3, and the height of the air bag 3 increases, so as to increase a pressure applied by the massage unit 2 to the lower back, thus increasing the massage strength; if lower massage strength is required, the user controls the air valve 13 to deflate the air bag 3 through the control button 7, and the height of the air bag 3 decreases, so as to reduce the pressure applied by the massage unit 2 to the lower back of the user, thus decreasing the massage strength; after the user turns off the massage unit, the air valve 13 can be controlled through the control button 7 to completely deflate the air bag 3, and the height of the air bag 3 decreases completely, so that the massage unit is thoroughly made to be away from the lower back of the user; and it is convenient to switch the use modes, so that the massage waist pillow is conveniently applicable to different use environments.

The above descriptions are only the preferred embodiments of the present utility model, and are not intended to limit the present utility model. Any modifications, equivalent replacements and improvements that are made within the spirit and principle of the present utility model shall fall within the protection scope of the present utility model.

What is claimed is:

1. A massage waist pillow, comprising:
a sponge waist pillow main body, a massage unit, an air bag, an air pump, an air valve and an electric control plate, wherein a groove is reserved in an area of the sponge waist pillow main body close to the back of the waist of a user; a support plate is arranged in the groove; the air bag is fixed on the support plate; the massage unit is arranged in the above groove and is located above the air bag; the air bag is arranged in an interlayer between the massage unit and the support plate; and an outer side of the air bag is fixedly connected with an air inlet and outlet hose.

2. The massage waist pillow according to claim 1, wherein the outline of the air bag is matched with the outline of the massage unit, and the air bag is fixed at a bottom of the massage unit.

3. The massage waist pillow according to claim 1, wherein the air bag is inflated to push the massage unit out of the groove, so that the massage unit protrudes towards an outer side of a plane of the sponge waist pillow main body; and the air bag is deflated to pull the massage unit into the groove, so that the massage unit moves towards one side of the bottom of the groove.

4. The massage waist pillow according to claim 1, wherein the air bag is connected to the air pump and the air valve respectively through the air inlet and outlet hose.

5. The massage waist pillow according to claim 1, wherein an outer surface of the sponge waist pillow main body is wrapped with a waist pillow cloth cover.

6. The massage waist pillow according to claim 1, wherein the electric control plate is connected to the air pump and the air valve through internal wires.

7. The massage waist pillow according to claim 1, wherein the electric control plate is connected to the massage unit through an internal wire.

8. The massage waist pillow according to claim 1, wherein a control box is mounted on an outer side of the sponge waist pillow main body; a button and the electric control plate are arranged in the control box; and the button is connected to the electric control plate.

9. The massage waist pillow according to claim 8, wherein the electric control plate in the control box is connected to a rechargeable battery through an internal wire; and the rechargeable battery supplies electric energy to the air pump, the air valve and the massage unit through the electric control plate.
